(19) United States
(12) Patent Application Publication
(10) Pub. No.: US 2024/0354537 A1
(43) Pub. Date: Oct. 24, 2024

(54) Color Correction Device, Printing System, Color Correction Method, And Non-Volatile Recording Medium

(71) Applicant: SEIKO EPSON CORPORATION, Tokyo (JP)

(72) Inventors: Takuya ONO, Shiojiri (JP); Takahiro KAMADA, Matsumoto (JP); Mitsuhiro YAMASHITA, Matsumoto (JP); Yuko YAMAMOTO, Shiojiri (JP)

(21) Appl. No.: 18/638,812

(22) Filed: Apr. 18, 2024

(30) Foreign Application Priority Data
Apr. 19, 2023 (JP) 2023-068306

(51) Int. Cl. G06K 15/02; B41J 2/21

(52) U.S. Cl. CPC G06K 15/1878; B41J 2/21; G06K 15/1822; G06K 15/1848; G06K 2215/101

(57) ABSTRACT

A color correction device includes a color conversion section configured to convert an input value of an input color space into an output value of an output color space, a selection section configured to receive selection of one or more color components as target color components from among a plurality of color components used in a printing device, and a correction section configured to corrects a output value. The correction section configured to, when the input value is a first type input value representing a color that does not include the target color component, execute a first correction process that corrects a first type output value corresponding to a first type input value so as to reduce the target color component. The correction section configured to, when the input value is a second type input value within a propagated correction range set around the first type input value in the input color space, a second correction process that corrects a second type output value corresponding to the second type input value in accordance with a position of the second type input value within the propagated correction range.

The present application is based on, and claims priority from JP Application Serial Number 2023-068306, filed Apr. 19, 2023, the disclosure of which is hereby incorporated by reference herein in its entirety.

### BACKGROUND

### 1. Technical Field

The present disclosure relates to a color correction device, a printing system, a color correction method, and a computer program.

### 2. Related Art

In a typical printing device, printing is executed using four types of color materials: C (cyan), M (magenta), Y (yellow), and K (black). When printing is performed, color conversion for converting an input value in an input color space into an output value in an output color space is executed in a printing data generation device such as a personal computer. In the color conversion, a color component that does not exist in the input value may appear in the output value. For example, when a patch formed of only a cyan color material is to be printed, even if the input value is only component C such as CMYK (90,0,0,0) the output value may include a component M or a component Y such as CMYK (89,1,2,0). Here, “CMYK (90,0,0,0)” means a color of C=90%, M=0%, Y=0%, and K=0%. When a color component that does not exist in the input value appears in the output value, color turbidity or granularity may be perceived. In order to avoid such turbidity and granularity, a technique called a “pure color protection” or a “single black protection” is known in which, if an input color represented by an input value is a single color of any of C, M, Y, and K, an output color represented by an output value is also a single color.

JP-A-2018-082360 discloses an image processing device that performs the pure color process. When an input color, which is a primary color or a secondary color, is multicolored by color conversion, the image processing device corrects an output color to the primary color or the secondary color by performing the pure color process. The output color is corrected so as to reduce the color difference between the input color and the output color. Processing of the primary colors in this related art corresponds to the “pure color protection”.

However, in the related art, there is a problem in that how to select a correction target of an output value in order to reduce color turbidity or granularity is not sufficiently devised. In the related art, there is a problem in that a large jump may occur between a color to which the pure color process is applied and a color in the vicinity thereof.

### SUMMARY

According to a first aspect of the present disclosure, a color correction device is provided. A color correction device includes a color conversion section configured to convert an input value of an input color space into an output value of an output color space, a selection section configured to receive selection of one or more color components as target color components from among a plurality of color components used in a printing device, and a correction section configured to, when the input value is a first type input value representing a color that does not include the target color component, execute a first correction process that corrects a first type output value corresponding to a first type input value so as to reduce the target color component and to, when the input value is a second type input value within a propagated correction range set around the first type input value in the input color space, a second correction process that corrects a second type output value corresponding to the second type input value in accordance with a position of the second type input value within the propagated correction range.

According to a second aspect of the present disclosure, there is provided a printing system including a color correction device and a printing device. The color correction device includes a color conversion section configured to convert an input value of an input color space into an output value of an output color space, a selection section configured to accept a selection of one or more color components as target color components from among a plurality of color components used in the printing device, a correction section configured to, when the input value is a first type input value representing a color that does not include the target color component, execute a first correction process that corrects a first type output value corresponding to a first type input value so as to reduce the target color component and to, when the input value is a second type input value within a propagated correction range set around the first type input value in the input color space, a second correction process that corrects a second type output value corresponding to the second type input value in accordance with a position of the second type input value within the propagated correction range, and a printing data generation section configured to generate printing data to be supplied to the printing device using the corrected output value corrected by the correction section.

According to a third aspect of the present disclosure, a color correction method is provided. The color correction method includes (a) converting an input value in an input color space into an output value in an output color space, (b) receiving selection of one or more color components as target color components from among a plurality of color components used in a printing device, (c) when the input value is a first type input value representing a color not including the target color component, executing a first correction process of correcting a first type output value corresponding to a first type input value so as to reduce the target color component, and (d) when the input value is a second type input value that is within the propagated correction range that is set around the first type input value in the input color space, executing a second correction process of correcting a second type output value corresponding to the second type input value in accordance with a position of the second type input value in the propagated correction range.

According to a fourth aspect of the present disclosure, a computer program is provided. The computer program executes (a) a process of converting an input value in an input color space into an output value in an output color space, (b) a process of receiving selection of one or more color components as target color components from among a plurality of color components used in a printing device, (c) a first correction process of, when the input value is a first type input value representing a color not including the target color component, correcting a first type output value corresponding to a first type input value so as to reduce the target color component, and (d) a second correction process of, when the input value is a second type input value that is within the propagated correction range that is set around the first type input value in the input color space, correcting a second type output value corresponding to the second type input value in accordance with a position of the second type input value in the propagated correction range.

### BRIEF DESCRIPTION OF THE DRAWINGS

FIG. 1 is an explanatory diagram illustrating configuration of a printing system.

FIG. 2 is an explanatory diagram illustrating an example of a configuration of an image processing device.

FIG. 3 is an explanatory diagram illustrating another example of configuration of the image processing device.

FIG. 4 is an explanatory diagram illustrating further another example of configuration of the image processing device.

FIG. 5 is an explanatory diagram illustrating an example of a color conversion lookup table.

FIG. 6 is an explanatory diagram illustrating an example of generation of granularity by color conversion and the non input color removal.

FIG. 7 is an explanatory diagram illustrating a comparison between the related-art pure color protection and the non input color removal of the present disclosure.

FIG. 8 is an explanatory diagram illustrating a selection example of a target color component.

FIG. 9 is an explanatory diagram illustrating a propagated correction range when a component C is set as a target color component.

FIG. 10 is an explanatory diagram illustrating the maximum coordinate value of the propagated correction range in the case where the component C is the target color component.

FIG. 11 is an explanatory diagram illustrating an example of the correction factor of the propagated correction when the component C is the target color component.

FIG. 12 is an explanatory diagram illustrating a processing example of the non input color removal and the propagated correction when a component C is set as a target color component.

FIG. 13 is an explanatory diagram illustrating the propagated correction range when the component Y is set as the target color component.

FIG. 14 is an explanatory diagram illustrating the maximum coordinate value of the propagated correction range when the component Y is the target color component.

FIG. 15 is an explanatory diagram illustrating a process example of the non input color removal and the propagated correction when a component Y is set as a target color component.

FIG. 16 is an explanatory diagram illustrating the propagated correction range when the CY component is the target color component.

FIG. 17 is an explanatory diagram illustrating a process example of the non input color removal and the propagated correction when a CY component is set as a target color component.

FIG. 18 is a flowchart illustrating an overall procedure of color correction process.

FIG. 19 is a flowchart illustrating a process procedure of step S30 in the first embodiment.

FIG. 20 is a flowchart illustrating a process procedure of step S30 in the second embodiment.

FIG. 21 is a flowchart illustrating the process procedure of step S100 in the second embodiment.

FIG. 22 is an explanatory view illustrating an example of color correction process in a second embodiment.

FIG. 23 is an explanatory diagram illustrating correction factor used in a third embodiment.

FIG. 24 is an explanatory diagram illustrating an example of color correction process in a third embodiment.

### DESCRIPTION OF EMBODIMENTS

### A. First Embodiment

### Configuration of Device

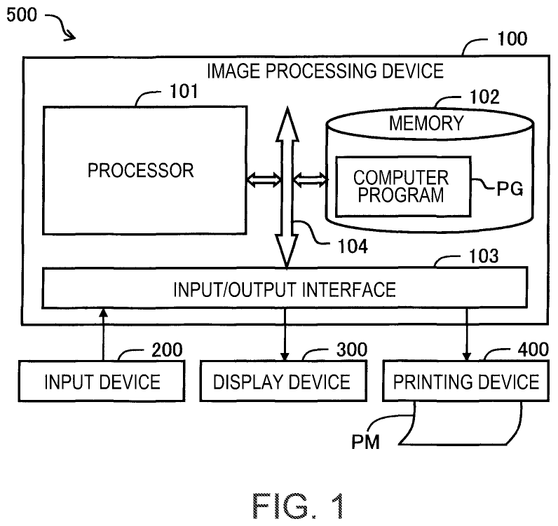

FIG. 1 is an explanatory diagram illustrating configuration of a printing system 500 according to the embodiment. The printing system 500 includes an image processing device 100, an input device 200, a display device 300, and a printing device 400. The image processing device 100 corresponds to a “color correction device” of the present disclosure.

The image processing device 100 includes a processor 101, a memory 102, an input/output interface 103, and an internal bus 104. The processor 101, the memory 102, and the input/output interface 103 are coupled to each other via the internal bus 104 so as to be capable of bidirectional communication. The memory 102 includes a volatile memory including a main memory and a video memory, and a non-volatile memory such as a hard disk, SSD (Solid State Drive). The input device 200, the display device 300, and the printing device 400 are coupled to the input/output interface 103 of the image processing g device 100 by wired communication or wireless communication. The input device 200 is, for example, a keyboard or a mouse, and the display device 300 is, for example, a liquid crystal display. The input device 200 and the display device 300 may be integrated as a touch panel. The printing device 400 is, for example, an inkjet printer, and prints an image on a printing medium PM using a plurality of types of ink. The printing device 400 can be configured as a digital textile printing device that prints an image on a printing medium PM made of fabric.

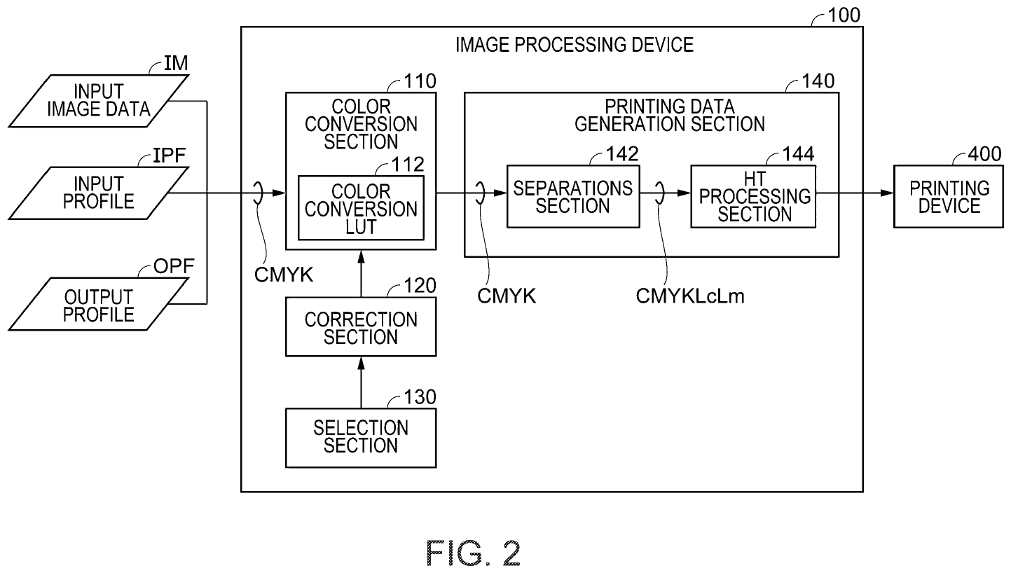

FIG. 2 is an explanatory diagram illustrating an example of a configuration of the image processing device 100. The image processing device 100 includes a color conversion section 110, a correction section 120, a selection section 130, and a printing data generation section 140. The functions of these sections are realized in a software manner by the processor 101 executing a computer program PG stored in advance in the memory 102. However, a part of the function of each section may be realized by a hardware circuit.

The color conversion section 110 executes a color conversion process for converting an input value in the input color space into an output value in the output color space using a color conversion lookup table 112. The color conversion lookup table 112 is created by combining the input profile IPF and the output profile OPF. The input profile IPF is an ICC profile used for color conversion from the input color space used in the input image data IM to a device independent color space. The input color space is, for example, a RGB color space or a CMYK color space. The device independent color space is, for example, the CIE-L*a*b* color space or the CIE-XYZ color space. The output profile OPF is an ICC profile used for color conversion from the device independent color space to an output color space for the printing device 400. Various color spaces such as a CMYK color space and a CMYKRG color space can be used as the output color space. The “CMYKRG color space” is a color space composed of six color components of C (cyan), M (magenta), Y (yellow), K (black), R (red), and G (green). The colors in the output color space are also referred to as “device colors”. In the example of FIG. 2, both the input color space and the output color space are CMYK color spaces.

The correction section 120 executes a color correction process (to be described later). The color correction process includes a process of correcting the output value so as to reduce the target color component when the input value represents a color not including the target color component. The selection section 130 receives the selection of the user regarding the target color component to be subjected to the color correction. As the target color components, for example, one or more color components are selected from among a plurality of device color components CMYK.

The printing data generation section 140 generates print data to be supplied to the printing device 400 using the corrected output value corrected by the correction section 120. The printing data generation section 140 includes a separations section 142 and a halftone processing section 144. The separations section 142 converts an output value of each pixel of the input image data IM converted by the color conversion section 110 into a density value of a plurality of color materials of the printing device 400. In the example of FIG. 2, the printing device 400 uses color materials of Lc (light cyan) and Lm (light magenta) in addition to and CMYK, and the separations section 142 converts the values CMYK of the respective pixels into density values of six color materials CMYKLCLm. The halftone processing section 144 generates print data by performing a halftone process using the density value of each pixel after the separation process. The printing device 400 executes printing in accordance with the print data transmitted from the printing data generation section 140.

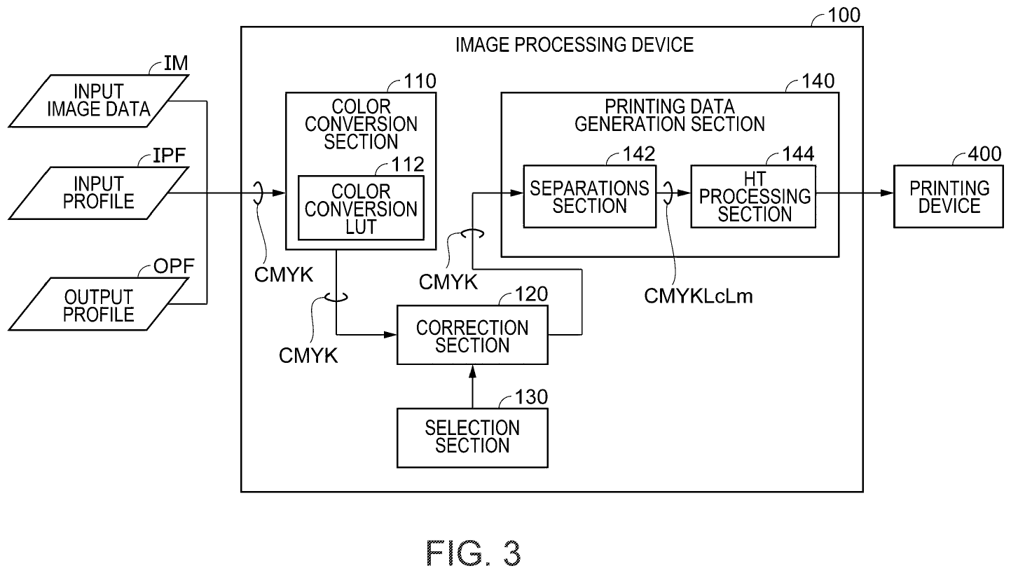

FIG. 3 is an explanatory diagram showing another example of the configuration of the image processing device 100. In this example, the correction section 120 corrects the output values CMYK converted by the color conversion section 110, and transmits the corrected output values to the printing data generation section 140. In this case as well, one or more color components of the plurality of color components CMYK of the device colors can be selected as target color components to be subjected to color correction.

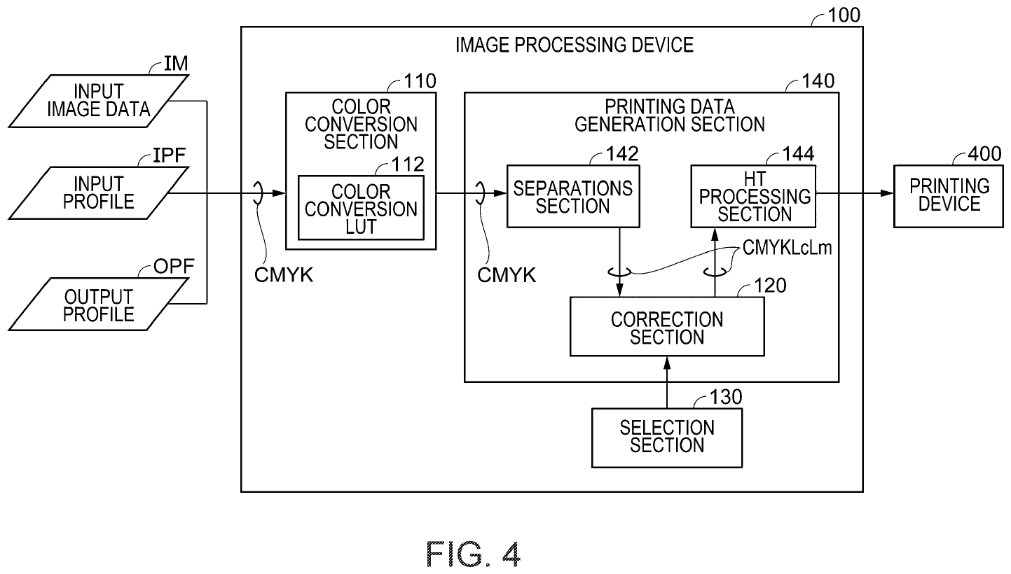

FIG. 4 is an explanatory diagram showing still another example of the configuration of the image processing device 100. In this example, the correction section 120 corrects the density value of the color material CMYKLcLm converted by the separations section 142, and transmits the corrected density value to the halftone processing section 144. In this case, the density value of the color material CMYKLcLm corresponds to an “outputted value after color conversion”. One or more color materials of the six color materials CMYKLcLm can be selected as target color components to be subjected to color correction.

When the target color component is the component Lc, the component Lc itself does not exist in the input color space CMYK. In this case, one of the following two methods can be used as a method of determining the values of the target color components Lc in the input values CMYK.

### 1. First Method

A method of assuming that the target color component Lc is not included in the input values CMYK when the value of the component C of the input values CMYK is 0 or equal to or greater than a threshold value and assuming that the target color component Lc is included in the input values CMYK when the value of the component C of the input values CMYK is a positive value less than the threshold value. As the threshold value, for example, a value of 15% to 25% can be used.

### 2. Second Method

A method of assuming that the value of the target color component Lc in the input value CMYK is 0 regardless of the actual value of the input value CMYK.

The selection section 130 may be configured to receive a selection from the user as to which of these methods is to be used.

As can be understood from the examples of FIGS. 2 to 4, as the “plurality of color components used in the printing device” selectable as the target color component, a plurality of color components of the device color may be used, or a plurality of color components corresponding to a plurality of color materials of the printing device may be used. However, the case in which the color component of the device color is selected as the target color component by mainly using the configuration described in FIG. 2 will be described below.

### Definition of Terms

Input color: A color represented by an input value of color conversion.
Output color: A color represented by an output value of color conversion.
Pure color protection: A type of color correction in the related art, and is a process of correcting an output value of color conversion when an input value includes only color components of primary colors such as C, M, and Y to only color components of the same primary colors as the input value.
C protection: Cyan pure color protection.
Non input color removal: A color correction that is a type of first correction process according to the present disclosure and that removes, from an output value, a color component which does not exist in a color represented by an input value.
C removal process: Cyan non input color removal.
Color removal plane: A plane in which one target color component is defined by input values of 0.
Non input color suppression: A color correction that is a type of first correction process according to the present disclosure and that reduces, in an output value, a color component that does not exist in a color represented by an input value.
Propagated correction: A correction that is a type of second correction process according to the present disclosure and that is applied to an output value corresponding to an input value in the vicinity of an input value for which the target color component is zero.
Propagated correction range: A range in the input color space to be subjected to propagated correction.
Target color component: A color component selected as a target of non input color removal or non input color suppression.
Non target color component: A color component to which neither non input color removal nor non input color suppression has been applied.
First type input value: An input value representing a color that does not include a target color component, and an output value corresponding to the input value is a processing target of the non input color removal or non input color suppression.
Second type input value: An input value within the propagated correction range.
Primary color: In subtractive color mixing, a color composed of one of the components CMY. In additive color mixing, a color composed of one of the components RGB.
Secondary color: A color composed of two color components.
Tertiary color: A color composed of three color
components.
Pure K: Black composed of the component K, and is represented by CMYK (0,0,0,k)
Composite K: Black represented only by CMY components, and is represented by CMYK (c,m,y,0).
Rich K: Black expressed by using all the component CMYK, and represented by CMYK (c,m,y,k).

In the present disclosure, the range of individual color components is 0% to 100%. White and black are represented as follows, for example.
CMYK (0,0,0,0): white.
CMYK (100,100,100,100): black.
RGB (0,0,0): black.
RGB (100,100,100): white.

### Contents of Color Correction Process

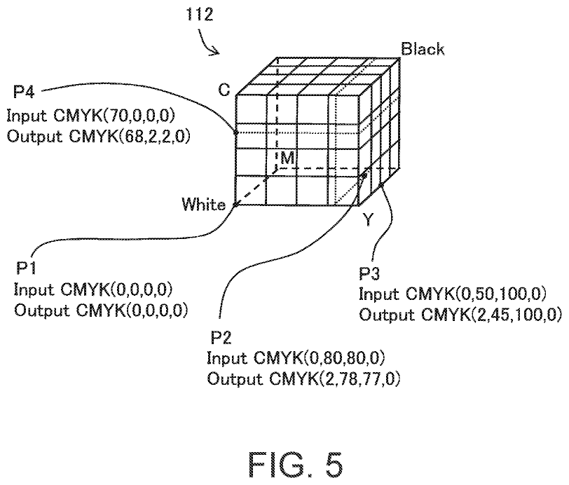

FIG. 5 is an explanatory diagram showing an example of the color conversion lookup table 112. Here, it is assumed that both the input color space and the output color space are CMYK. In FIG. 5, assuming the case of K=0, a three dimensional color solid consisting of the three color components CMY of the input values is depicted. This color solid has an origin of White (paper white), and is defined by three coordinate axes of a C axis, an M axis, and Y axes which are orthogonal to each other. A plurality of lattice points are set in the color solid. However, in FIG. 5, only main grid lines and lattice points are shown for convenience of illustration. Each of a plurality of lattice points of the color solid represents an input color. The color conversion lookup table 112 is a table in which an output value is registered for an input value corresponding to a coordinate value of each lattice point. In this example, for four lattice points P1 to P4, input values CMYK (0,0,0,0), CMYK (0,80,80,0), CMYK (0,50,100,0), and CMYK (70,0,0,0) and corresponding output values CMYK (0,0,0,0), CMYK (2,78,77,0), CMYK (2,45,100,0), and CMYK (68,2,2,0) are shown. An input value and an output value of color conversion represent the same color in a device independent color space such as the CIE-L*a*b* color space or the CIE-XYZ color space, but a color component that does not exist in the input value may appear in the output value. In this case, color turbidity or granularity may occur in an image reproduced by the output value.

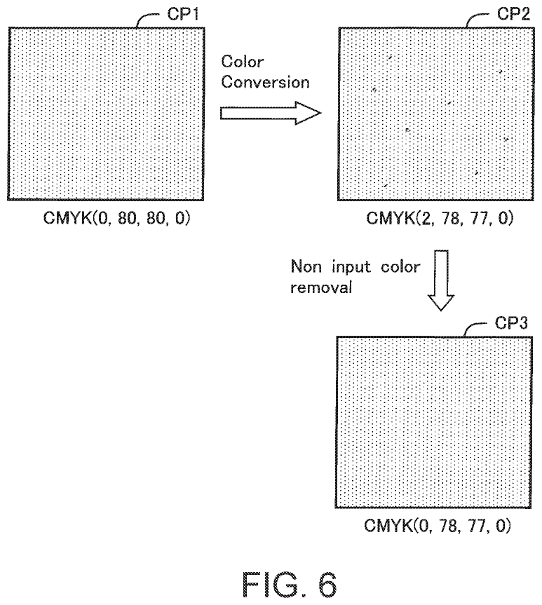

FIG. 6 is an explanatory diagram showing an example of generation of granularity due to color conversion, and the non input color removal. In this example, a first color patch CP1 represented by the input values CMYK (0,80,80,0) of the lattice point P2 of FIG. 5 and a second color patch CP2 reproduced by the post-color conversion values CMYK (2,78,77,0) are drawn. The first color patch CP1 is composed of substantially uniform secondary colors of Magenta and Yellow. On the other hand, dots of the ink of Cyan are formed here and there in the second color patch CP2 because the output value includes 2% of the component C. Since a color material of a color component that does not exist in the input value is mixed in the second color patch CP2, there is a possibility that color turbidity or granularity is perceived.

In particular, in a case where the printing medium PM is cloth, the color turbidity becomes a large problem. For example, in a case where printed matter such as POP (Point of Purchase advertising), posters, apparel, or the like is created using the printing medium PM made of cloth, a printed image is required to be uniform and smooth. Therefore, the occurrence of color turbidity in an image region having a uniform color becomes a problem. So, in a case where the printing medium PM made of cloth is used, it is particularly desirable to suppress the occurrence of color turbidity.

The non input color removal, which is a type of color correction according to the present disclosure, is a process of removing, from an output value, a target color component that is not included in a color represented by an input value. In a case where the component C is selected as the target color component, when the non input color removal is applied to the output value CMYK (2,78,77,0), the component C, which is not included in the input value CMYK (0,80,80,0), is removed from the output value, and the corrected output value CMYK (0,78,77,0) is obtained. The color patch CP3 reproduced with the corrected output value CMYK (0,78,77,0) is reproduced with substantially uniform secondary colors of Magenta and Yellow, so that color turbidity and granularity do not occur. As will be described later, the non input color removal can be applied to a primary color or a multi-order color of a tertiary color or more.

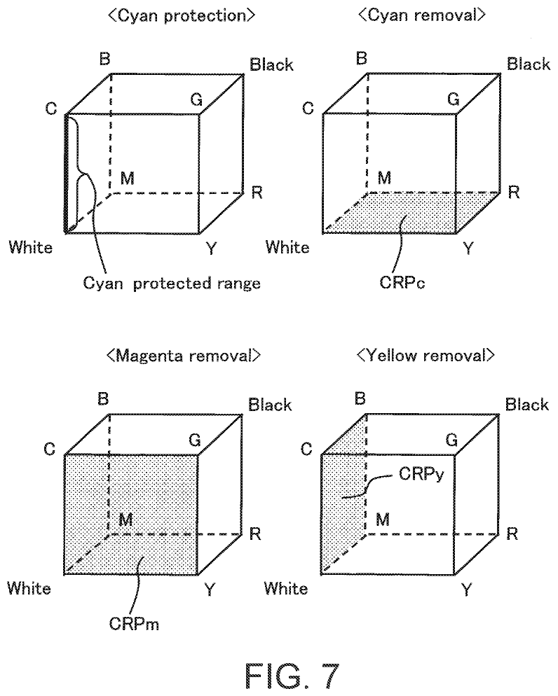

FIG. 7 is an explanatory diagram showing a comparison between the pure color protection in the related art and the non input color removal of the present disclosure. Here, a C protection is illustrated as an example of a related-art pure color protection. Input colors to be subject to the C protection are colors at lattice points on the C axis indicated by thick lines in the upper left diagram of FIG. 7. The C protection is correction for setting the output value at the lattice points of the input value CMYK (c,0,0,0) to CMYK (c′,0,0,0).

FIG. 7 further depicts subjected regions for C removal process, M removal process, and Y removal process as the non input color removal according to this disclosure. These non input color removal are performed on the input colors of the lattice points group existing on the surface of the color solid. In the case of C removal process, the lattice points group in which the component C of the input value is 0 is the target, and the hatched MY plane is the target of the non input color removal. This MY plane is called the “color removal plane CRPc”. The color removal plane CRPc is a plane defined by input values of as the component C is 0. In the above-described example of FIG. 6, when the C removal process is applied to the output value CMYK (2,78,77,0), the component C that are not included in the input value CMYK (0,80,80,0) are removed from the output value, and the corrected output value CMYK (0,78,77,0) is obtained. The same applies to M removal process and Y removal process. That is, in the M removal process, the CY plane becomes the color removal plane CRPm which is the target region of the non input color removal, and in the Y removal process, the CM plane becomes the color removal plane CRPy which is the target region of the non input color removal. Since the CMYK color space is a four dimensional color space, for example, the color removal plane CRPc in which the input values of the component C is 0 and constitute a hyperplane of the four dimensional space. Since it is difficult to illustrate such a hyperplane, the hyperplane is represented by a plane of a three dimensional space in FIG. 7.

In the present disclosure, a user can arbitrarily select a target color component to be a target of the non input color removal. For example, when the M removal process and the Y removal process are used together, the component M and the component Y are removed from the output value of the lattice points on the C axis, and only the component C remains.

By allowing the user to arbitrarily select a target color component to be subjected to the non input color removal, it is possible to reduce problematic color turbidity and granularity. For example, when the purpose is to reduce color turbidity as described with reference to FIG. 6, if the cause of turbidity is Cyan, a sufficient effect can be obtained by C removal process. In this case, it is not necessary to select all of CMYK as the target color components, and only the component C may be selected as the target color components.

It is also possible to apply K removal process in which the target color component of the non input color removal is K (black). For example, when the input value CMYK (20,20,20,0) is converted into the output value CMYK (18,18,18,2) by the color conversion, the corrected output value CMYK (18,18,18,0) can be obtained by applying the K removal process. In this example, the input value CMYK (20,20,20,0) is the Composite K, but the output value CMYK (18,18,18,2) is the Rich K mixed with K. When the K removal process is applied to this, the corrected output value CMYK (18,18,18,0) becomes the Composite K. As a result, it is possible to express uniform solid painted gray without granularity by not using the K ink. In this example, the non input color removal is applied to the tertiary color. However, in a case where the input value CMYK (80,80,80,0) is converted into the output value CMYK (30,30,30,60), when the K removal process is applied, the corrected output value becomes CMYK (30,30,30,0), and a problem occurs in that the density becomes completely different gray. Therefore, in such a case, it is desirable not to select the component K as the target color component.

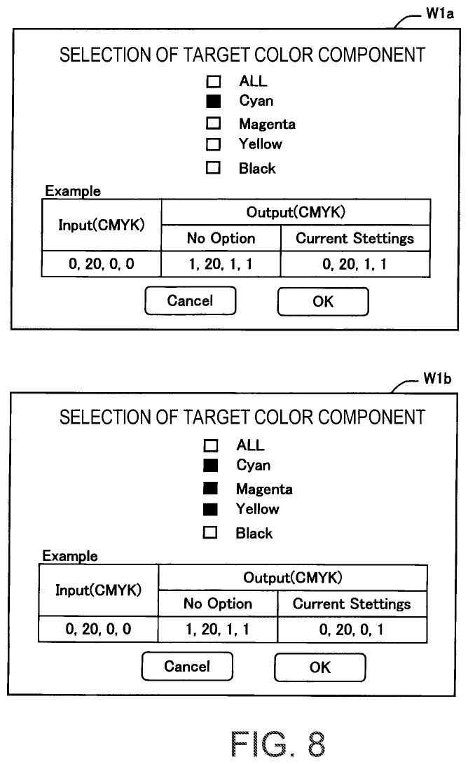

FIG. 8 is an explanatory diagram showing a selection example of the target color component. The selection section 130 displays a selection window on the display device 300, thereby allowing the user to select a target color component. In the first selection window W1a, Cyan is selected as the target color element. This means that only the component C are selected as target color component. In the lower part of the selection window W1a, input values and output values of the process example are shown. “No option” is an example of an output value when non input color removal is not applied, and “Current Settings” is an example of a corrected output value when the non input color removal is applied to the selected target color components. In the process example of the selection window W1a, the component C is corrected to 0 by applying the non input color removal. In the second selection window W1b, Cyan Magenta, and Yellow are selected as the target color components. In the process example of the selection window W1b, the non input color removal is performed to the component C and the component Y, and they are corrected to 0. The process example may be omitted.

The non input color removal of the present disclosure is also applicable to a case where the color material used in the printing device 400 is other than CMYK. For example, it will be assumed that the printing device 400 performs printing using six color materials of C (cyan), M (magenta), Y (yellow), K (black), R (red), and G (green). In this case, any one or more color components of the six color components CMYKRG can be selected as the target color components of the non input color removal. To be specific, when the input value CMYKRG (10,10,10,10,0,0) is converted into the output value CMYKRG (10,10,10,10,2,2) by the color conversion, if two or more color components including the component R and the component G are selected as the target color components, the output value can be corrected into CMYKRG (10,10,10,10,0,0).

In general, assuming that N is an integer of 3 or more, the selection section 130 is desirably configured to accept selection of any one or more and N or less number of color components as target color components, from among N-number of color components corresponding to N-number of color materials used in the printing device 400. In particular, it is desirable that three or more color components can be arbitrarily selected as target color components. In this way, the color correction process can be performed on a desired number of target color components from one to N.

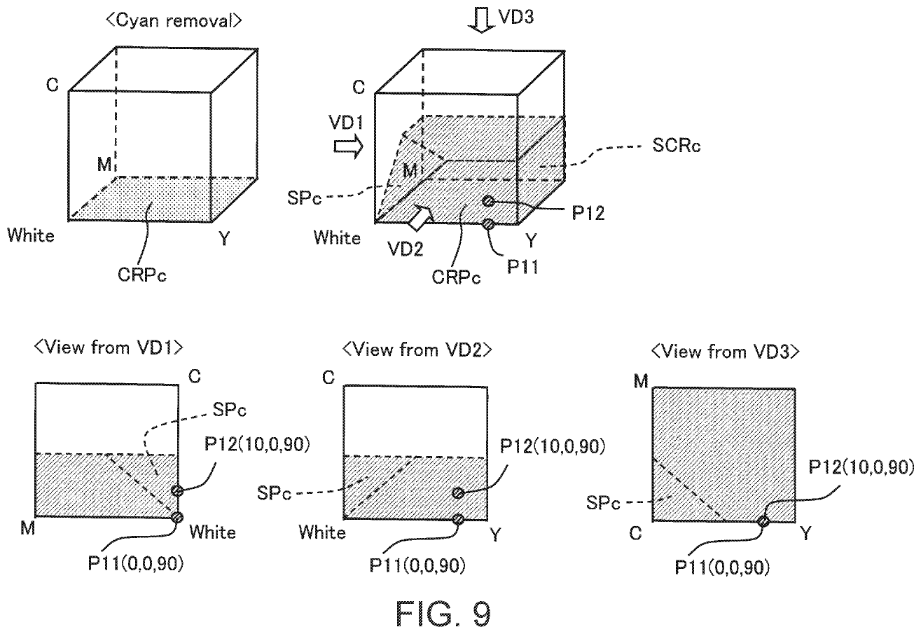

FIG. 9 is an explanatory diagram illustrating the propagated correction range SCRc in a case where the component C is the target color component. In FIG. 9, for simplicity, it is assumed that the input color space is the CMY color space. The same applies to other examples of the propagated correction range described later. However, the present disclosure is not limited to the case where the input color space is the CMY color space, and can be applied to any other input color space.

The propagated correction range SCRc is a range in contact with the color removal plane CRPc in the input color space. The color removal plane CRPc is a plane where the component C is 0. The propagated correction related to the C removal process is executed on the output value obtained by color converting the input value existing in the propagated correction range SCRc. The non input color removal corresponds to “first correction process” of the present disclosure, and the propagated correction corresponds to “second correction process” of the present disclosure. In the propagated correction range SCRc, two input points P11 and P12 are exemplified. The coordinates (c,m,y) of the input point P11 are (0,0,90) and are present on the color removal plane CRPc. The coordinates (c,m,y) of the input point P12 are (10,0,90) and are present in the propagated correction range SCRc. The propagated correction range SCRc and the input points P11 and P12 are drawn in the lower part of FIG. 9, as the input color space is seen from the three viewing directions VD1, VD2 and VD3.

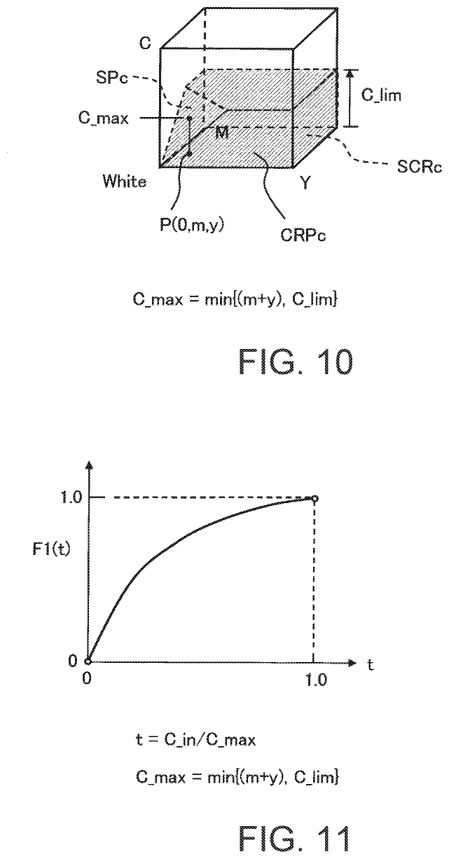

FIG. 10 is an explanatory diagram showing the maximum coordinate value C_max of the propagated correction range SCRc when the component C is the target color component. The propagated correction range SCRc is set so as to spread to a position where the propagated correction range SCRc is distant from the color removal plane CRPc by the maximum coordinate value C_max. The maximum coordinate value C_max is given by, for example, the following equation:

$$C\_max = min \{ m ( m + y ) , C\_lim \} \qquad ( q1 )$$

Here, C_max is the maximum value of the C coordinate value of the propagated correction range SCRc existing directly above an arbitrary grid position P (0,m,y) of the color removal plane CRPC, and C_lim is a limit value set in advance. The limit value C_lim is set, for example, to a value in the range of 20% to 50%. In the present embodiment, C_lim=50% is used.

As described above, the propagated correction range SCRc is desirably set according to the total values (m+y) of the color components other than the target color component C in the input value. To be more specific, the propagated correction range SCRc is desirably set so that the distance from the color removal plane CRPc extends to a position where the distance from the color removal plane CRPC is equal to the smaller of the total value (m+y) of the color components other than the target color component C in the input value and the preset limit value C_lim.

The propagated correction range SCRc has a shape obtained by cutting off a part of a rectangular parallelepiped, which has the color removal plane CRPc as the bottom surface and a height from the bottom surface of C_lim, across an inclined plane SPc represented by c=m+y. The first reason for cutting a part of the rectangular parallelepiped across the inclined plane SPc is that since the values of the components CMY near the origin of the color solid are small and the effect of the propagated correction is also small, priority is given to the processing speed and the propagated correction near the origin is skipped. The second reason is to reduce a region in which a plurality of propagated correction ranges overlap each other because the content of the propagated correction becomes complicated when the plurality of propagated correction ranges overlap each other. However, the propagated correction range SCRc is not limited to such a shape, and may be set to any other shape. For example, the surface facing the color removal plane CRPc may be formed by only the inclined plane SPc, or the inclined plane SPc may be omitted and the propagated correction range SCRc may be formed in a rectangular parallelepiped shape. However, if the propagated correction range SCRc having the shape as shown in FIG. 10 is used, the overlap with the propagated correction ranges for the other target color components can be reduced, and the color jump caused by the non input color removal can be appropriately mitigated.

The propagated correction is not applied to the output value corresponding to the input value existing on the color removal plane CRPc, and is also not applied to the output value corresponding to the input value at the position where the distance from the color removal plane CRPc is the maximum coordinate value C_max. For example, since the input point P11 is located on the color removal plane CRPC, the propagated correction is not applied to the output value corresponding to the input point P11, and the non input removal process is applied. On the other hand, since the input point P12 is not located on the color removal plane CRPc but located within the propagated correction range SCRc, the propagated correction is applied to the output value corresponding to the input point P12.

Propagated correction when the component C is set as the target color component can be executed, for example, in accordance with the following equation:

$$C\_out ⋆ = C\_out \times F 1 ( t ) \qquad ( q2 )$$

$$t = C\_in / C\_max \qquad ( q3 )$$

Here, C_out is the value of the component C in the output value before the propagated correction, C_out* is the value of the component C after the propagated correction, C_in is the value of the component C in the input value, and F1 (t) is a correction factor with t as a parameter.

FIG. 11 is an explanatory diagram illustrating examples of the correction factor F1 (t) of the propagated correction when the component C is set as the target color component. The correction factor F1 (t) is factor of less than 1 that increases as the values C_in of the target color component in the input value increase. The correction factor F1 (t) becomes smaller as the input value is closer to the color removal plane CRPc with respect to an arbitrary input value existing inside the propagated correction range SCRc. Note that, F1 (0)=0, and F1 (1)=1. However, since the point of t=0 is on the color removal plane CRPc, it is not a target of the propagated correction. The point of t=1 corresponds to the position where the distances from the color removal plane CRPc are the maximum coordinate values C_max, and thus is not a target of the propagated correction. By applying the propagated correction using such a correction factor F1 (t), it is possible to prevent a large jump from appearing in the color represented by the corrected output value after the color correction.

In the example of FIG. 11, the correction factor F1 (t) indicates a characteristic of an upwardly convex curve, but may indicate a characteristic of a downwardly convex curve, or may indicate a characteristic of a straight line. However, it is desirable that the correction factor F1 (t) has a characteristic of an upwardly convex curve because the color jump is less likely to be visually found out.

It is also possible to perform the propagated correction according to the following equation instead of the above equation (q2):

$$C\_out ⋆ = C\_out + Δ C \times ( 1 - F 1 ( t ) ) \qquad ( q4 )$$

Here, ΔC is the amount of change in the component C due to non input color removal, and is a negative value.

The above-described equation (q2) is a process for obtaining the correction values of the target color component by multiplying the values C_out of the target color component by the factor F1 (t), which is less than 1 and which increases as the value of the target color component in the input value increase. On the other hand, the above equation (q4) is a process for obtaining the correction values of the target color component by multiplying the change amount ΔC of the target color component removed in the non input color removal by the factor (1−F1 (t)), which is less than 1 and which decreases as the value of the target color components in the input value increases, and by adding the multiplication result to the values C_out of the target color component in the output value. These two processes are equivalent to each other because they give the same result by adjusting the correction factor F1 (t) in the equations (q2) and (q4) as needed.

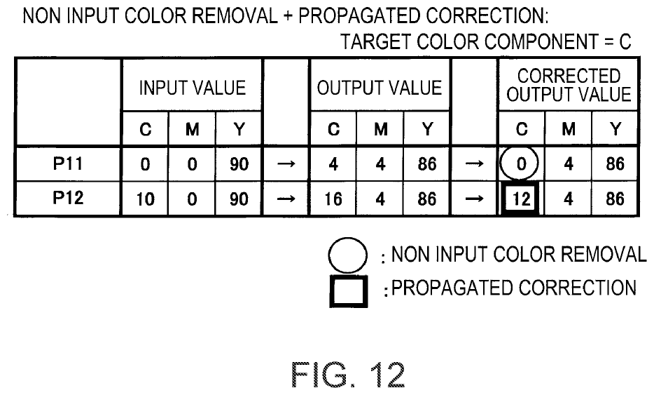

FIG. 12 is an explanatory diagram illustrating a process example of the non input color removal and the propagated correction in a case where a component C is set as a target color component. “Corrected output value” is an output value to which the non input color removal and the propagated correction are applied. In “corrected output value”, the number that is surrounded by a circle is a value of the color component changed by the non input color removal and the number that is surrounded by a thick line frame is a value of the color component changed by the propagated correction. Since the component C of the input value is 0 in the input point P11, the non input color removal is applied to the input point P11. Since the input point P12 exists in the propagated correction range SCRc, the propagated correction is applied to the input point P12. The difference between the color represented by the corrected output value of the input point P11 and the color represented by the corrected output value of the input point P12 is smaller than that in the case where the propagated correction is not performed.

In the example of FIG. 12, the input value of the input point P11 corresponds to a “first type input value representing a color that does not include target color components”. The input value of the input point P12 corresponds to a “second type input value within the propagated correction range”.

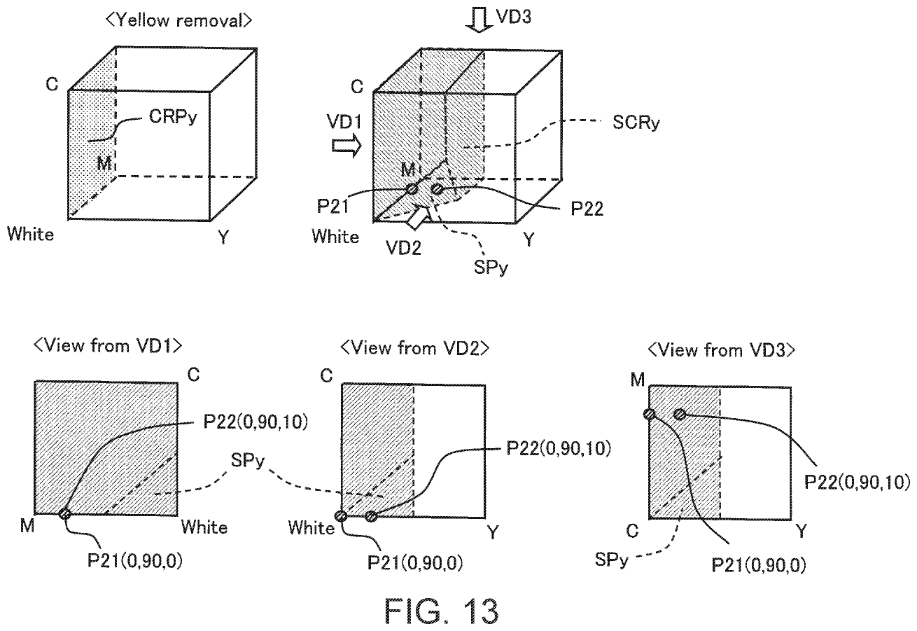

FIG. 13 is an explanatory diagram showing the propagated correction range SCRy when the component Y is set as the target color component. The propagated correction range SCRy is a range in contact with the color removal plane CRPy in the input color space. In the propagated correction range SCRy, two input points P21 and P22 are exemplified. The coordinates (c,m,y) of the input point P21 are (0,90,0) and are present on the color removal plane CRPy. The coordinates (c,m,y) of the input point P22 are (0,90,10) and are present in the propagated correction range SCRy.

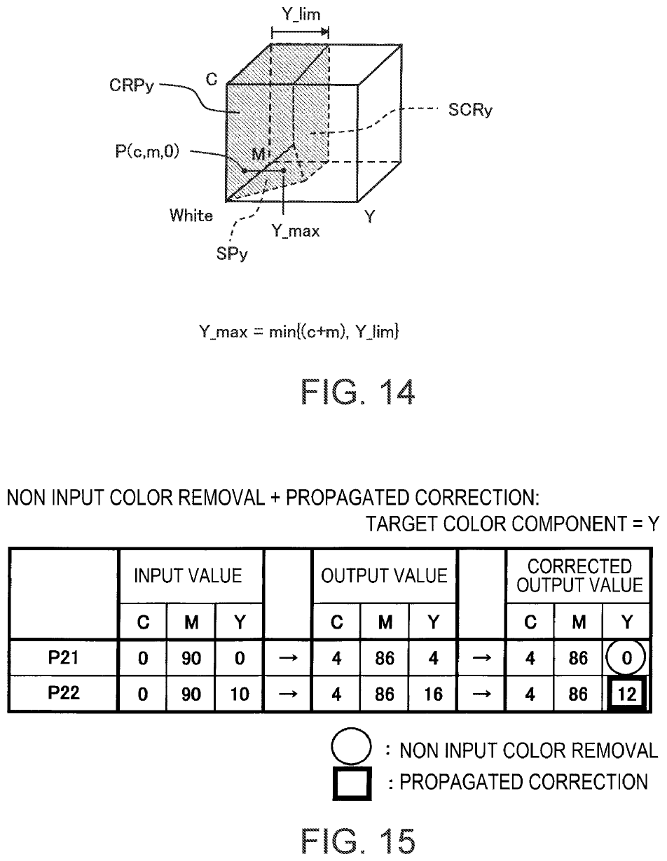

FIG. 14 is an explanatory diagram showing the maximum coordinate value Y_max of the propagated correction range SCRy when the component Y is the target color component. The propagated correction range SCRy is set so as to spread to a position where the maximum coordinate value Y_max, which is the maximum distance from the color removal plane CRPy, is obtained. The maximum coordinate value Y_max is given, for example, by the following equation:

$$Y\_max = min \{ ( c + m ) , Y\_lim \} \qquad ( q5 )$$

Here, Y_max is the maximum value of the Y coordinate value of the propagated correction range SCRy existing immediately above an arbitrary grid position P (c,m,0) of the color removal plane CRPy, and Y_lim is a limit value set in advance. The limit value Y_lim is set, for example, to a value in the range of 20% to 50%. The limit value Y_lim is desirably set to the same value as the limit value C_lim when the component C is set as the target color component. In the present embodiment, Y_lim=50% is used.

As described above, the propagated correction range SCRy is desirably set according to the target color component and the total value (c+m) of the color components other than Y in the input value. To be more specific, it is desirable that a distance between the color removal plane CRPy and the propagated correction range SCRy is set to spread to a position equal to the smaller value of the total value (c+m) of the color components other than the target color component C in the input value and the preset limit value Y_lim.

The propagated correction range SCRy has a shape obtained by cutting off a part of a rectangular parallelepiped, which has the color removal plane CRPy as a bottom surface and which has a height of from the bottom surface of Y_lim, across an inclined plane SPy represented by y=c+m. By applying the propagated correction to the input values existing in the propagated correction range SCRy, the color jump caused by the non input color removal can be reduced.

The propagated correction in the case where the component Y is set as the target color component can be executed, for example, according to the following equations:

$$y\_out ⋆ = y\_out \times F 1 ( t ) \qquad ( q6 )$$

$$t = y\_in / Y\_max \qquad ( q7 )$$

Here, Y_out is the value of the component Y in the output value before the propagated correction, Y_out* is the value of the component Y after the propagated correction, Y_in is the value of the component Y in the input value, and F1 (t) is the correction factor illustrated in FIG. 11.

FIG. 15 is an explanatory diagram illustrating a process example of the non input color removal and the propagated correction when the component Y is the target color component. Since the input value of component Y is 0 on the input point P21, non input color removal is applied to the input point P21. Since the input point P22 exists in the propagated correction range SCRy, the propagated correction is applied to the input point P22. The difference between the color represented by the corrected output value at the input point P21 and the color represented by the corrected output value at the input point P22 is smaller than that in the case where the propagated correction is not performed.

In the example of FIG. 15, the input value of the input point P21 corresponds to a “first type input value representing a color that does not include the target color component”. The input value of the input point P22 corresponds to a “second type input value within the propagated correction range”.

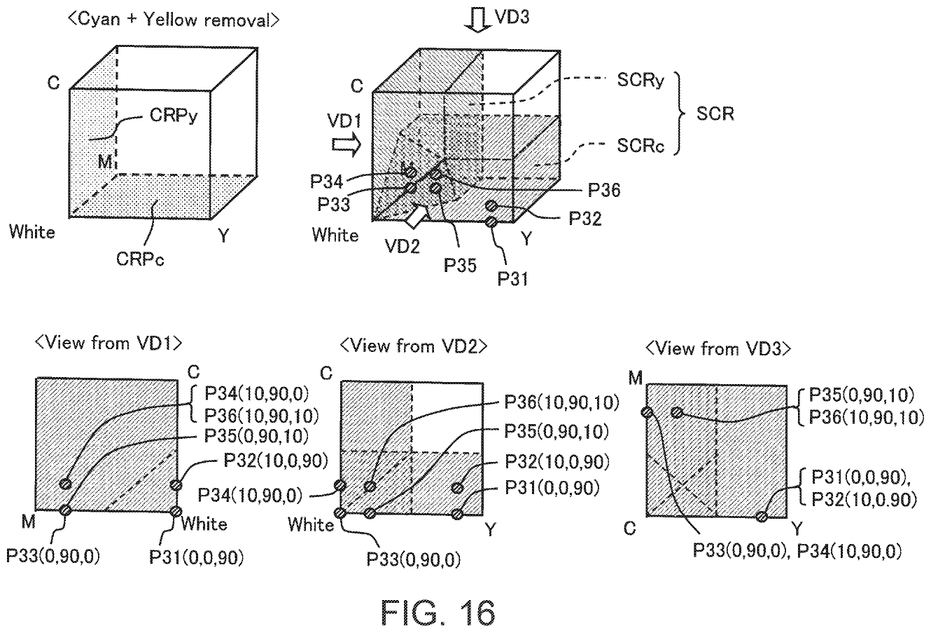

FIG. 16 is an explanatory diagram illustrating the propagated correction range SCR, when the component C and the component Y are set as the target color components. The propagated correction range SCR corresponds to a range obtained by summing the propagated correction range SCRc for the component C and the propagated correction range SCRy for the component Y. FIG. 16 illustrates six input points P31 to P36.

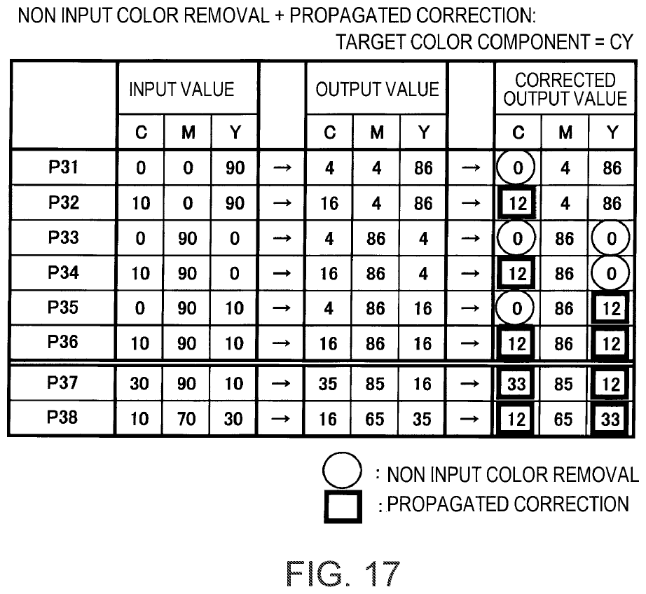

FIG. 17 is an explanatory diagram illustrating a process example of the non input color removal and the propagated correction in a case where the component C and the component Y are the target color components. The application status of non input removal process and the propagated correction to the six input points P31 to P36 in FIG. 16 is as follows:
1. Input point P31: Since the input value of the component C is 0, the non input color removal has been applied to the component C.
2. Input point P32: Since the component C exists in the propagated correction range SCRc, the propagated correction is applied to the component C.
3. Input point P33: Since the input values of the component C and the component Y are 0, the non input color removal is applied to the component C and the component Y.
4. Input point P34: Since the component Y of the input value is 0 and exists within the propagated correction range SCRc, the non input color removal is applied to the component Y, and the propagated correction is applied to the component C.
5. Input point P35: Since the component C of the input value is 0 exists within the propagated correction range SCRy, the non input color removal is applied to the component C and the propagated correction is applied to the component Y.
6. Input point P36: Since it is located at the position where both the propagated correction range SCRc and the propagated correction range SCRy exist, the propagated correction is applied to the component C and the component Y.

FIG. 17 further shows processing results for two input points P37 and P38 which are not shown in FIG. 16.
7. Input point P37: Similarly to the input point P36, since it is located at the position where the propagated correction range SCRc and the propagated correction range SCRy overlap, the propagated correction is applied to the component C and the component Y. However, since the distance of the input point P37 from the color removal plane CRPy is smaller than the distance of the input point P37 from the color removal plane CRPc, the correction factor of the component Y in the propagated correction is smaller than the correction factor of the component C.
8. Input point P38: Similarly to the input point P37, since it is located where both the propagated correction range SCRc and the propagated correction range SCRy exist, the propagated correction is applied to the component C and the component Y. However, contrary to the input point P37, since the distance of the input point P38 from the color removal plane CRPy is greater than the distance of the input point P38 from the color removal plane CRPc, the correction factor of the component Y in the propagated correction is larger than the correction factor of the component C.

The input points P36 to P38 are exampled in which the propagated correction is applied to two color components. The propagated correction can be applied to three or more color components in the same manner. In general, when the number of target color components to be subjected to the first correction process is N, the propagated correction range is set so as to include N-number of propagated correction ranges in contact with N-number of color removal planes in which one of the N-number of color components is zero, where N is an integer of 2 or more. When the position of the input value in the input color space is included in M-number of propagated correction ranges among N-number of propagated correction ranges, the output value is corrected so that the values of M-number of color components among N-number of color components are respectively corrected according to the position of the input value in M-number of propagated correction ranges, where M is an integer of 2 or more and N or less.

As described above, at the input point P34, the non input color removal is applied to one target color component, and the propagated correction is applied to another target color component. The same applies to the input point P35. As described above, when a plurality of color components are selected as target color components, the non input color removal and the propagated correction may be simultaneously applied to an output value obtained from one input value. In this way, even when the non input color removal is applied to the plurality of target color components, the color jump due to the non input color removal can be reduced.

In FIGS. 9 to 17 described above, both the input color space and the output color space are the CMY color space, but the non input color removal and the propagated correction can also be applied to a case where another color space such as the CMYK color space, the CMYKRG color space, or the RGB color space is used.

When the input color space and the output color space are each composed of n color components X1 to Xn, the propagated correction range for the target color component Xj can be defined as the propagated correction range to a position where the distance from the color removal plane, where the target color component Xj are 0, are equal to the maximum coordinate value Xj_max given by the following equation, where n is an integer of 3 or more:

$$Xj\_max = min \{ ( \sum Xi - Xj , Xj\_lim \} \qquad ( q8 )$$

Here, Xj_max is the maximum value of the Xj coordinate value of the propagated correction range existing immediately above an arbitrary position on the color removal plane where the target color components Xj are 0, ΣXi is the sum of all the color components X1 to Xn of the input value, Xj is the target color component of the input value, and Xj_lim is a preset limit value. The limit value Xj_lim is set, for example, to a value in the range of 20% to 50%. The equation (q8) is a generalized equation of the equations (q1) and (q5).

As shown in the above equation (q8), the propagated correction range is desirably set according to the total value (Σ Xi−Xj) of the color components other than the target color component Xj in the input value. More specifically, the propagated correction range is desirably set so as to spread to a position where the distance from the color removal plane is equal to the smaller value of the total value (Σ Xi−Xj) of the color components other than the target color component Xj in the input value and the preset limit value Xj_lim.

The above-described equations (q2), (q3), (q6), and (q7) can be generalized as follows:

$$Xj\_out ⋆ = Xj\_out \times F 1 ( t ) \qquad ( q9 )$$

$$t = Xj\_in / Xj\_max \qquad ( q10 )$$

Here, Xj_out is the value of the target color component in the output value before the propagated correction, Xj_out* is the value of the target color component after the propagated correction, Xj_in is the value of the target color component in the input value, and F1 (t) is the correction factor illustrated in FIG. 11.

When the input color space is RGB and the output color space is CMYK, the values of the CMY components in the input values can be regarded as being equal to the CMY values obtained by converting the input values RGB by the following conversion equations:

$$Ci = ( 1 - Ri ) \qquad ( q11 )$$

$$Mi = ( 1 - Gi ) \qquad ( q12 )$$

$$Yi = ( 1 - Bi ) \qquad ( q13 )$$

Here, Ri, Gi, and Bi are the color components of the input values, and Ci, Mi, and Yi are the CMY components corresponding to the RGB components of the input values. Ri, Gi, and Bi and Ci, Mi, and Yi are values in the range of 0 to 1, where the value “1” corresponds to 100%.

The value of the component K in the input values RGB can be determined by one of the following methods.

### 1. Method M1a:

The value Ki of the component K in the input value RGB is determined according to the following equation:

$$Ki = min ( Ci , Mi , Yi ) \qquad ( q14 )$$

### 2. Method M1b:

It is assumed that the component K is 0 regardless of the actual value of the input values RGB.

The selection section 130 may be configured to receive the selection of one of the methods M1a and M1b from the user.

Whether the input color represented by the input value Ri, Gi, and Bi corresponds to a primary color, a secondary color, or a tertiary color is also determined based on the Ci, Mi, and Yi components. That is, among the Ci, Mi, and Yi components obtained by converting arbitrary input values Ri, Gi, and Bi using the equations (q11) to (q13), when only one of the color components is not 0 and the other two color components are 0, the input color represented by the input value is a “primary color”. When only two of the components among components Ci, Mi, and Yi are not 0 and the other one is 0, the input color is a “secondary color”. If none of the Ci, Mi, and Yi components is 0, the input color is a “tertiary color”. In this way, even when the input color space is RGB, the non input color removal can be performed for various input colors from a primary color to a tertiary color.

When the input color space is CMYK and the output color space is RGB, the values of the components CMY corresponding to the output values can be regarded as being equal to the values CMY obtained by converting the output values RGB by the following conversion equations:

$$Co = ( 1 - Ro ) \qquad ( q15 )$$

$$Mo = ( 1 - Go ) \qquad ( q16 )$$

$$Yo = ( 1 - Bo ) \qquad ( q17 )$$

Here, Ro, Go, and Bo are color components of the output values, and Co, Mo, and Yo are components CMY corresponding to the RGB components of the output values. Ro, Go, and Bo and Co, Mo, and Yo are values in the range of 0 to 1, respectively, where the value “1” corresponds to 100%.

The value of the component K in the output values RGB can be determined by one of the following methods.

### 1. Method M2a

The value Ko of the component K in the output value RGB is determined according to the following equation:

$$Ko = min ( Co , Mo , Yo ) \qquad ( q18 )$$

### 2. Method M2b

It is considered that the component K is 0 regardless of the actual value of the output value RGB.

The selection section 130 may be configured to receive the selection of one of the methods M2a and M2b from the user.

The input values CMYK are 0, and the color components of output values RGB, corresponding to the components CMY for which the values Co, Mo, and Yo obtained by the equations (q15) to (q17) are not 0, are corrected to 100% by the non input color removal. This correction is substantially equivalent to correcting the values of the components CMY selected as the target color components to zero. As can be understood from this example, the correction of increasing the component R of the output value RGB corresponds to the correction of decreasing the component C, which is the target color component. Similarly, the correction of increasing the component G of the output values RGB corresponds to the correction of decreasing the component M, which is the target color component, and the correction of increasing the component B of the output values RGB corresponds to the correction of decreasing the component Y, which is the target color component.

### Processing Procedure

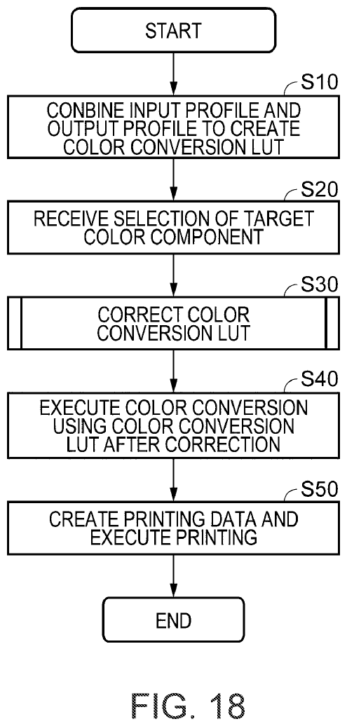

FIG. 18 is a flowchart showing the overall procedure of the color correction process. In step S10, the color conversion section 110 creates the color conversion lookup table 112 by combining the input profile IPF and the output profile OPF. In step S20, the selection section 130 receives the selection of target color components to be subjected to color correction from the user. The target color component is selected using, for example, the selection window shown in FIG. 8. In step S30, the correction section 120 corrects the contents of the color conversion lookup table 112.

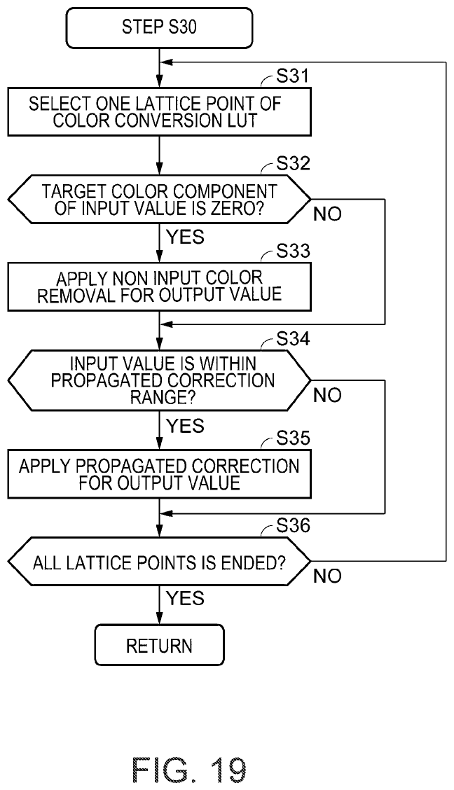

FIG. 19 is a flowchart showing the process procedure of step S30 according to the first embodiment. Here, it is assumed that the input color space is CMYK.

In step S31, the correction section 120 selects one lattice point of the color conversion lookup table 112. This step corresponds to a process of converting an input value in the input color space into an output value in the output color space. In step S32, the correction section 120 determines whether or not a target color component is 0 in the input values CMYK of the selected lattice point. When a target color component in the input values CMYK is not 0, the process proceeds to step S34 described below. On the other hand, when a target color component in the input value CMYK is 0, the process proceeds to step S33, and the correction section 120 corrects the target color component of the input values. That is, the target color component of the output value is corrected to 0 by applying non input color removal. In step S34, the correction section 120 determines whether or not the input values CMYK of the selected lattice point exist within the propagated correction range. If the input values are not within the propagated correction range, the process proceeds to step S36 described below. When the input value is within the propagated correction range, the process proceeds to step S35, and the correction section 120 applies the propagated correction to the output value corresponding to the input value. The corrected output value is obtained through the processes of these steps S32 to S35.

The correction section 120 updates the output value of the color conversion lookup table 112 with the corrected output value. In step S36, the correction section 120 determines whether or not the processes of steps S31 to S35 have been completed for all lattice points of the color conversion lookup table 112. When there is a lattice point that has not been processed, the process returns to step S31, and the processes of steps S31 to S35 are performed again. When the process has been completed for all the lattice points, the process of step S30 is terminated, and the process proceeds to step S40.

In step S40, the color conversion section 110 performs color conversion on the input image data IM using the corrected color conversion lookup table 112. In step S50, the printing data generation section 140 generates printing data using the color converted image data, and transfers the printing data to the printing device 400 to execute printing.

Although the color correction is executed for the lattice points of the color conversion lookup table 112 in the process procedure of FIGS. 18 and 19, the color correction may be executed for the output of the color conversion section 110 or the output of the separations section 142 as shown in FIGS. 3 and 4. However, if color correction is executed for the lattice points of the color conversion lookup table 112, appropriate color conversion can be executed for a large number of input image data using the corrected color conversion lookup table 112. If the color correction is executed for the lattice points of the color conversion lookup table 112, it is not necessary to perform the color correction for each pixel of the input image data, so that there is an advantage that the process speed is high.

According to the first embodiment described above, in a case where the target color component is not included in the color represented by the input value, the target color component in the output value is removed, and thus it is possible to suppress the occurrence of color turbidity or granularity. Since one or more target color components can be selected, correction process can be executed for a desired number of target color components. Since the propagated correction is applied to the output value corresponding to the input value existing within the propagated correction range, it is possible to prevent a large jump from occurring in the color after the correction.

### B. Second Embodiment

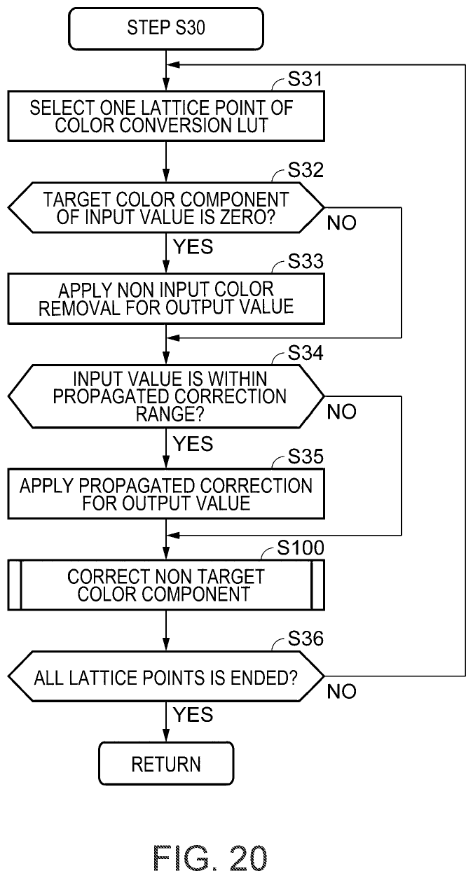

FIG. 20 is a flowchart showing the process procedure of step S30 in the second embodiment. The device configuration shown in FIGS. 1 and 2 is the same as that of the first embodiment. The entire procedure of the processes shown in FIG. 18 is also the same as that of the first embodiment. In the process procedure of FIG. 20, a step S100 is added between the step S35 and the step S36 of the process procedure shown in FIG. 19, and the other steps are the same as those of FIG. 19.

In step S100, the correction section 120 corrects the non target color component for the output value to which at least one of the non input color removal and the propagated correction has been applied. Here, the “non target color component” means a color component to which the non input color removal or the propagated correction is not applied. Note that, the color component whose input value is 0 may be excluded from the target of non target color component correction. In other words, the target of the non target color component correction may be color components whose values in the input values are not 0 among the color components to which the non input color removal or the propagated correction is not applied. The correction of the non target color components in step S100 is executed so as to reduce a dispersion in color due to the color correction including at least one of the non input color removal and the propagated correction. The correction of the non target color component can be performed by using various calculations. For example, an operation of multiplying the value before correction by a positive factor may be used. Alternatively, the operation that a constant value is added to or subtracted from the pre-correction value may be used. Alternatively, the corrected value may be determined by the following procedure.

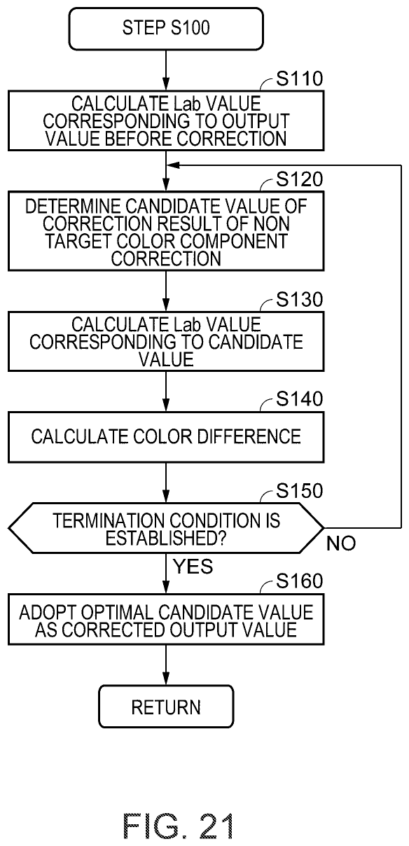

FIG. 21 is a flowchart showing the process procedure of step S100 in the second embodiment. In step S110, the correction section 120 obtains the Lab values for the pre-correction outputs. The “Lab value” means an L*a*b* value in the CIE-L*a*b* color system. The process of step S110 can be performed by inverse conversion using the output profile OPF. In step S120, the correction section 120 determines a candidate value of the correction result of the non target color component correction. The initial value of the candidate value may be an arbitrary value. In step S130, the correction section 120 obtains the Lab value for the candidate value. This process can also be executed by inverse transformation using the output profile OPF. In step S140, the correction section 120 calculates the color difference from the Lab value obtained in step S110 and the Lab value obtained in step S130. In step S150, the correction section 120 determines whether or not a preset termination condition is satisfied. As the termination condition, for example, a condition that the color difference is equal to or less than a preset allowable value can be used. Alternatively, a condition that the number of times of execution of the process of steps S120 to S140 reaches a preset upper limit number of times or more may be used. When the termination condition is not satisfied, the process returns to step S120, and the processes of steps S120 to S150 are executed again. At this time, in step S120, the next candidate value is searched. The search for candidate values may be performed using an optimization algorithm. When the termination condition is satisfied, the process proceeds to step S160, and the correction section 120 adopts the optimum candidate value as the corrected output value. As the “optimal candidate value”, for example, a candidate value having the smallest color difference is selected from among a plurality of candidate values.

In the process of FIG. 21 described above, the corrected output value is determined so as to reduce the color difference, but instead of this, the corrected output value may be determined so as to reduce the difference in at least one of chroma, brightness, and hue.

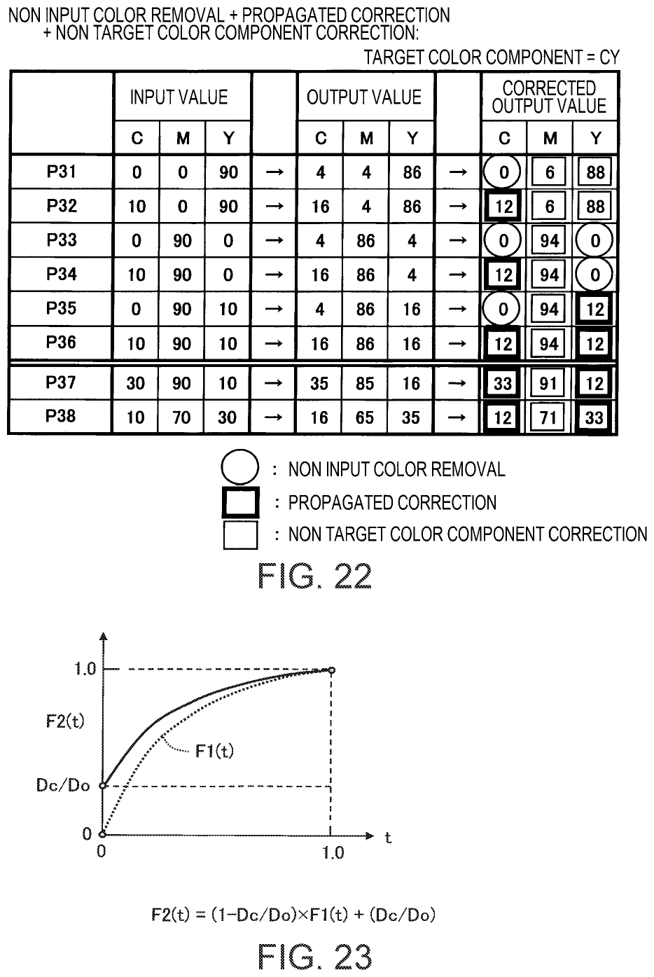

FIG. 22 is an explanatory diagram showing an example of color correction process in the second embodiment. This example corresponds to a result obtained by adding the correction of non target color components in step S100 to the process example shown in FIG. 17. In the corrected output value, a number surrounded by a double frame is a value of the color component changed by the correction of the non target color component. In this example, all color components that have not been subjected to the non input color removal or the propagated correction are the target of the non target color component correction. Non target color component correction is executed so as to reduce a dispersion in color due to the color correction including at least one of the non input color removal and the propagated correction. By correcting the non target color components in this way, it is possible to prevent the color from becoming excessively different due to the non input color removal or the propagated correction of the target color components. Specifically, it is possible to reduce a color difference between colors before and after color correction, or a difference in at least one of chroma, brightness, and hue.

The second embodiment also has the same effect as the first embodiment. In the second embodiment, a dispersion in color due to correction can be reduced.

### C. Third Embodiment

In the first embodiment and the second embodiment described above, non input color removal is executed on the target color components, but in the third embodiment, non input color suppression is executed instead of non input color removal. “Non input color suppression” is color correction for reducing a target color component which does not exist in a color represented by an input value from an output value. In the non input color suppression, the value of the target color component is desirably reduced and changed to a correction value that is not zero.

The correction value of the target color component after the non input color suppression is calculated by, for example, the following equation:

$$Dc = min ( k 1 \times Do , Dmax ) \qquad ( q19 )$$

Wherein, Dc is the corrected value of the target color component, Do is the value of the target color component before correction, min( ) is a function that selects and outputs the smaller value, k1 is a positive factor less than 1, and Dmax is the upper limit value. The upper limit value Dmax is set in advance as a value at which color turbidity or granularity is not perceived. The results of k1×Do may be subjected to a rounding operation such as round-up, round-down, or round-off to the nearest whole number. When round-up is applied as the rounding operation, the correction values Dc of the target color components can be set to positive values other than 0.

For example, it is assumed the case that the target color element is C, the input value of the color conversion is CMY(0,0,90) and the outputs values are CMY (4,4,86). In this case, when the non input color removal described in the first embodiment is applied, the corrected output value is CMY (0,4,86). On the other hand, when the non input color suppression that k1=0.5 and Dmax=3% is applied, the corrected output value becomes CMY (2,4,86) and the component C decreases to a value other than 0.

The upper limit values Dmax at which color turbidity and granularity are not perceived may be stored in the output profile OPF. Alternatively, the upper limit value Dmax may be acquired in association with the printing device 400 or may be set by the user. A manufacturer or a user of the printing device 400 can set the upper limit value Dmax that was evaluated as not being problematic by actually executing printing.

When the target color components are CMY and the output color space is RGB, the non input color suppression is a process of increasing the RGB values corresponding to CMY, which are the target color components.

When the non input color suppression is applied, since the target color component of the output color is reduced in a case where the target color component is not included in the input color, it is possible to obtain printed material with little color turbidity or granularity. When the non input color removal described in the first embodiment is applied, the color difference between the input color and the output color may increase. On the other hand, when the non input color suppression is applied, the color difference between the input color and the output color can be reduced as compared with the non input color removal. When the non input color suppression is applied, the correction of the non target color component described in the second embodiment may also be applied.

When the non input color suppression is applied to the target color component, the propagated correction of the target color component is executed, instead of the above equations (q9) and (q10), in accordance with the following equations:

$$Xj\_out ⋆ = Xj\_out \times F 2 ( t ) \qquad ( q20 )$$

$$F 2 ( t ) = ( 1 - Dc / Do ) \times F 1 ( t ) + ( Dc / Do ) \qquad ( q21 )$$

$$t = Xj\_in / Xj\_max \qquad ( q22 )$$

FIG. 23 is an explanatory diagram showing a correction factor F2 (t) given by the above-mentioned equation (q21). The correction factor F2 (t) corresponds to values obtained by compressing the range of values of the correction factor F1 (t) shown in FIG. 11 to (1−Dc/Do) times and further adding (Dc/Do) thereto. FIG. 23 also shows a graph of the correction factor F1 (t) shown in FIG. 11. It can be seen that the value of correction factor F2 (t) is greater than the value of correction factor F1 (t) for the same parameter t. When such a correction factor F2 (t) is used, color correction can be executed such that a color to which non input color suppression is applied and a color to which propagated correction is applied smoothly change.

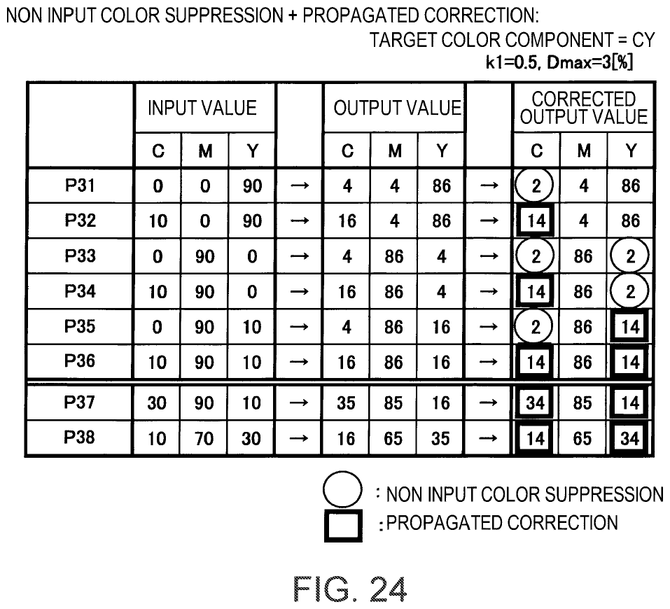

FIG. 24 is an explanatory diagram showing an example of color correction process in the third embodiment. The device configuration shown in FIGS. 1 and 2 is the same as that of the first embodiment. The entire procedure of the processes shown in FIG. 18 is also the same as that of the first embodiment. The example in FIG. 24 corresponds to a result obtained by applying the non input color suppression according to the above equation (q19) instead of the non input color removal and applying the propagated correction according to the above equations (q20) to (q22) in the example shown in FIG. 17. In this example, k1=0.5 and Dmax=3% are set.

Instead of the above equation (q19), the following equation may be used:

$$Dc = K 1 \times Do \qquad ( q23 )$$

Also in the case of using the equation (q23), it is possible to realize the non input color suppression for reducing the value of the target color component in the output value.

Both of the equations (q19) and (q23) correspond to the calculation for obtaining the corrected value Dc by multiplying the value Do of the target color components in output value by the positive factor k1 that is less than 1. When the value of the target color component is corrected by such a calculation, it is possible to suppress the occurrence of color turbidity or granularity, and to reduce a dispersion in color due to the correction of the output value.

According to the third embodiment, when the target color component is not included in the color represented by the input value, the target color component in the output value is decreased. Therefore, it is possible to suppress the occurrence of color turbidity or granularity, and to reduce a dispersion in color due to the correction of the output value.

### Other Forms

The present disclosure is not limited to the above-described embodiments, and can be implemented in various forms without departing from the scope of the present disclosure. For example, the present disclosure can also be realized by the following aspects. The technical features in the above-described embodiment corresponding to the technical features in each aspect described below can be appropriately replaced or combined in order to solve a part or all of the problems of the present disclosure or in order to achieve a part or all of the effects of the present disclosure. If the technical features are not described as essential in this specification, the technical features can be appropriately deleted.

1. According to a first aspect of the present disclosure, a color correction device is provided. The color correction device includes a color conversion section configured to convert an input value of an input color space into an output value of an output color space, a selection section configured to receive selection of one or more color components as target color components from among a plurality of color components used in a printing device, and a correction section configured to, when the input value is a first type input value representing a color that does not include the target color component, execute a first correction process that corrects a first type output value corresponding to a first type input value so as to reduce the target color component and to, when the input value is a second type input value within a propagated correction range set around the first type input value in the input color space, a second correction process that corrects a second type output value corresponding to the second type input value in accordance with a position of the second type input value within the propagated correction range.

According to the color correction device, since the target color component in the output value is reduced when the target color component is not included in the color represented by the input value, it is possible to suppress the occurrence of color turbidity or granularity. Since one or more target color components can be selected, correction process can be executed for a desired number of target color components. Since the correction suitable for each of the first type input value representing the color not including the target color component and the second type input value within the propagated correction range set around the first type input value is applied to the output value, it is possible to prevent a large jump from occurring in the color after the correction.

2. In the color correction device, the second correction process may be a process of correcting the second type output value by multiplying the value of the target color component by a factor that is less than 1 and that increases as the value of the target color component in the second type input value increases.

According to the color correction device, it is possible to prevent a large jump from occurring between the color represented by the corrected output value obtained by correcting the output value of the first type input value and the color represented by the corrected output value obtained by correcting the output value of the second type input value.

3. In the color correction device, the propagated correction range may be set corresponding to a total value of color components other than the target color component in the first type input value.

According to this color correction device, the propagated correction range can be set to an appropriate range.

4. In the color correction device, the propagated correction range may be in contact with a color removal plane in which the target color component is zero and is set so as to spread to a position where a distance from the color removal plane is equal to a smaller value of a total value of color components other than the target color component in the first type input value or a preset limit value.

According to this color correction device, the propagated correction range can be set to an appropriate range.

5. In the color correction device, in a case where the target color components to be subjected to the first correction process are N-number of color components, the propagated correction range may include N-number of propagated correction ranges in contact with N-number of color removal planes in which one of the N-number of color components is zero, N being an integer of 2 or more.

According to this color correction device, it is possible to appropriately set N-number of propagated correction ranges for N-number of color components.

6. In the color correction device, in a case where the position of the second type input value in the input color space is included in M-number of propagated correction ranges of the N-number of propagated correction ranges, the second type output value may be corrected so that the values of M-number of color components of the N-number of color components are respectively corrected according to the position of the second type input value in M-number of propagated correction ranges, M being an integer of 2 or more and N or less.

According to this color correction device, the propagated correction can be appropriately executed for the M-number of color components.

7. In the color correction device, correction of the first type output value that reduces the target color component may be a process of correcting the first type output value so as to change the value of the target color component to a correction value that is not zero.

According to the color correction device, a dispersion in color due to the correction of the output value can be reduced.

8. In the color correction device, the correction section may correct an output value component corresponding to a color component other than the target color component among the plurality of color components with respect to each of the first type output value and the second type output value to reduce a difference between colors before and after correction.

According to the color correction device, it is possible to prevent the color from being excessively different due to the correction.

9. In the color correction device, the color conversion section may include the color conversion section may include a color conversion lookup table for converting the input color space into the output color space and the correction section may perform the first correction process and the second correction process on the color conversion lookup table.

According to this color correction device, the appropriate color conversion can be executed using the corrected color conversion lookup table.

10. According to a second aspect of the present disclosure, there is provided a printing system including a color correction device and a printing device. The color correction device includes a color conversion section configured to convert an input value of an input color space into an output value of an output color space, a selection section configured to accept a selection of one or more color components as target color components from among a plurality of color components used in the printing device, a correction section configured to, when the input value is a first type input value representing a color that does not include the target color component, execute a first correction process that corrects a first type output value corresponding to a first type input value so as to reduce the target color component and to, when the input value is a second type input value within a propagated correction range set around the first type input value in the input color space, a second correction process that corrects a second type output value corresponding to the second type input value in accordance with a position of the second type input value within the propagated correction range, and a printing data generation section configured to generate printing data to be supplied to the printing device using the corrected output value corrected by the correction section.

11. According to a third aspect of the present disclosure, a color correction method is provided. The color correction method includes (a) converting an input value in an input color space into an output value in an output color space, (b) receiving selection of one or more color components as target color components from among a plurality of color components used in a printing device, (c) when the input value is a first type input value representing a color not including the target color component, executing a first correction process of correcting a first type output value corresponding to a first type input value so as to reduce the target color component, and (d) when the input value is a second type input value that is within the propagated correction range that is set around the first type input value in the input color space, executing a second correction process of correcting a second type output value corresponding to the second type input value in accordance with a position of the second type input value in the propagated correction range.

12. According to a fourth aspect of the present disclosure, a non-transitory computer-readable storage medium storing a computer program is provided. The computer program executes (a) a process of converting an input value in an input color space into an output value in an output color space, (b) a process of receiving selection of one or more color components as target color components from among a plurality of color components used in a printing device, (c) a first correction process of, when the input value is a first type input value representing a color not including the target color component, correcting a first type output value corresponding to a first type input value so as to reduce the target color component, and (d) a second correction process of, when the input value is a second type input value that is within the propagated correction range that is set around the first type input value in the input color space, correcting a second type output value corresponding to the second type input value in accordance with a position of the second type input value in the propagated correction range.

The present disclosure can also be realized in various forms other than the image processing device, the printing system, and the a non-transitory computer-readable storage medium storing a computer program. For example, the present invention can be realized in the form of an image processing method, non-transitory recording media in which a computer program is recorded, and the like.

What is claimed is:

1. A color correction device comprising:
a color conversion section configured to convert an input value of an input color space into an output value of an output color space;
a selection section configured to receive selection of one or more color components as target color components from among a plurality of color components used in a printing device; and
a correction section configured to, when the input value is a first type input value representing a color that does not include the target color component, execute a first correction process that corrects a first type output value corresponding to a first type input value so as to reduce the target color component and to, when the input value is a second type input value within a propagated correction range set around the first type input value in the input color space, a second correction process that corrects a second type output value corresponding to the second type input value in accordance with a position of the second type input value within the propagated correction range.

2. The color correction device, according to claim 1, wherein
the second correction process is a process of correcting the second type output value by multiplying the value of the target color component by a factor that is less than 1 and that increases as the value of the target color component in the second type input value increases.

3. The color correction device, according to claim 1, wherein
the propagated correction range is set corresponding to a total value of color components other than the target color component in the first type input value.

4. The color correction device, according to claim 3, wherein
the propagated correction range is in contact with a color removal plane in which the target color component is zero and is set so as to spread to a position where a distance from the color removal plane is equal to a smaller value of a total value of color components other than the target color component in the first type input value or a preset limit value.

5. The color correction device, according to claim 1, wherein
in a case where the target color components to be subjected to the first correction process are N-number of color components, the propagated correction range includes N-number of propagated correction ranges in contact with N-number of color removal planes in which one of the N-number of color components is zero, N being an integer of 2 or more.

6. The color correction device, according to claim 5, wherein
in a case where the position of the second type input value in the input color space is included in M-number of propagated correction ranges of the N-number of propagated correction ranges, the second type output value is corrected so that the values of M-number of color components of the N-number of color components are respectively corrected according to the position of the second type input value in M-number of propagated correction ranges, M being an integer of 2 or more and N or less.

7. The color correction device, according to claim 1, wherein
correction of the first type output value that reduces the target color component is a process of correcting the first type output value so as to change the value of the target color component to a correction value that is not zero.

8. The color correction device, according to claim 1, wherein
the correction section corrects an output value component corresponding to a color component other than the target color component among the plurality of color components with respect to each of the first type output value and the second type output value to reduce a difference between colors before and after correction.

9. The color correction device, according to claim 1, wherein
the color conversion section includes a color conversion lookup table for converting the input color space into the output color space and
the correction section performs the first correction process and the second correction process on the color conversion lookup table.

10. A printing system comprising:
a color correction device and
a printing device, wherein
the color correction device includes
a color conversion section configured to convert an input value of an input color space into an output value of an output color space,
a selection section configured to accept a selection of one or more color components as target color components from among a plurality of color components used in the printing device,
a correction section configured to, when the input value is a first type input value representing a color that does not include the target color component, execute a first correction process that corrects a first type output value corresponding to a first type input value so as to reduce the target color component and to, when the input value is a second type input value within a propagated correction range set around the first type input value in the input color space, a second correction process that corrects a second type output value corresponding to the second type input value in accordance with a position of the second type input value within the propagated correction range, and
a printing data generation section configured to generate printing data to be supplied to the printing device using the corrected output value corrected by the correction section.

11. A color correction method comprising:
(a) converting an input value in an input color space into an output value in an output color space;
(b) receiving selection of one or more color components as target color components from among a plurality of color components used in a printing device;
(c) when the input value is a first type input value representing a color not including the target color component, executing a first correction process of correcting a first type output value corresponding to a first type input value so as to reduce the target color component; and
(d) when the input value is a second type input value that is within the propagated correction range that is set around the first type input value in the input color space, executing a second correction process of correcting a second type output value corresponding to the second type input value in accordance with a position of the second type input value in the propagated correction range.

12. A non-transitory computer-readable storage medium storing a computer program, the program executing:
(a) a process of converting an input value in an input color space into an output value in an output color space;
(b) a process of receiving selection of one or more color components as target color components from among a plurality of color components used in a printing device;
(c) a first correction process of, when the input value is a first type input value representing a color not including the target color component, correcting a first type output value corresponding to a first type input value so as to reduce the target color component; and
(d) a second correction process of, when the input value is a second type input value that is within the propagated correction range that is set around the first type input value in the input color space, correcting a second type output value corresponding to the second type input value in accordance with a position of the second type input value in the propagated correction range.
